(19) United States
(12) Patent Application Publication
(10) Pub. No.: US 2008/0119765 A1
(43) Pub. Date: May 22, 2008

(54) Post-knee-surgery/injury range-of-motion improvement

(76) Inventors: Christopher M. Meckel, Carmel, CA (US); Jon-Peter Meckel, Carmel, CA (US)

Correspondence Address: ROBERT D. VARITZ, P.C., 4915 SE 33RD PLACE, PORTLAND, OR, 97202, US

(21) Appl. No.: 11/985,194

(22) Filed: Nov. 13, 2007

Related U.S. Application Data
(60) Provisional application No. 60/860,572, filed on Nov. 21, 2006.

(51) Int. Cl. A61H 1/02; A61H 1/00

(52) U.S. Cl. 601/34; 601/23; 601/5

(57) ABSTRACT

An active, patient-implementable, angular range-of-motion recovery practice, and associated structure, usable with respect to a knee including, from a methodologic point of view, (a) a occupying a sitting position, (b) by such occupying, defining a common swing plane for the upper and lower leg, (c) supporting the foot for back-and-forth, defined-swing-plane, rolling-contact motion over and in contact with an underlying motion-guidance surface, with such motion taking place generally within the defined swing plane, and (d) then swinging the lower leg in a fore-and-aft manner within the defined plane. The structure of the invention includes a rolling-motion traveler for supporting the underside of a patient's foot during practice of the invention, and a cooperative instruction set describing proper patient use of the traveler.

### CROSS REFERENCE TO RELATED APPLICATION

This application claims filing date priority to previously filed, currently co-pending U.S. Provisional Patent Application Ser. No. 60/860,572, filed Nov. 21, 2006, for “Post-Knee-Replacement Range of Motion Improvement.” The entire disclosure content of this previously filed Provisional Patent Application is hereby incorporated herein by reference.

### BACKGROUND AND SUMMARY OF THE INVENTION

This invention pertains to the regaining, restoring, and improving of angular range of motion in a knee joint under circumstances where something, such as a knee injury, or knee surgery, such as knee-replacement surgery, has causes a diminution of angular range of motion respecting the affected knee joint. In particular, it relates to both structure and a methodology which promotes significant and relatively rapid improvement in such a range-of-motion condition, driven importantly by patient-provided, active motive power.

For the purpose of illustration herein, a preferred and best-mode embodiment of, and, manner of practicing, the invention are described herein in the setting of post-knee-replacement surgery, an area of medical concern wherein the invention has been found to offer particular utility. Accordingly, it should be understood that all references herein to knee-replacement surgery are to be understood to be references also to any of the above-suggested condition involving loss of knee angular range of motion.

Proposed by the invention, in terms of apparatus, is a preferably foot-sized traveler having a foot-support platform with an upwardly facing foot-support expanse adapted to receive, during implementation of the methodology of the invention, the underside of the foot associated with the leg wherein knee replacement surgery has taken place. This traveler includes a body which possesses the mentioned platform having the also mentioned foot-support expanse, with the body, on its underside, being equipped, preferably, with front and rear pairs of rollers that accommodate foot-supported, continuous rolling contact (involving rolling contact of at least one underlying wheel) of the traveler over and in relation to an underlying, motion-guidance support surface, such as a floor in a building, or a surface in a specially prepared platform-like component having such a surface which may be either horizontal, or inclined in different manners, or shaped in other, different ways. Preferably, the mentioned foot-support expanse is upwardly arched, i.e., upwardly, convexly arched, in a fore-and-aft configuration, with the body of the traveler specifically possessing a forward and upwardly disposed inclination resulting from the use of the preferred, front and rear roller pairs wherein roller diameters are different, and specifically wherein the diameters of the front rollers are alike, and are greater than those (also alike) of the rear rollers.

Various modifications may be made in the traveler to produce different kinds of configurations, such as differently shaped foot-support expanses, such as (a) a completely flat expanse, (b) an expanse which does not possess the inclined condition just mentioned, and (c) an expanse which may be articulated by a hinge axis which extends transversely relative to the long axis of the traveler, somewhat centrally between the front and rear ends of the traveler's body. Different numbers of underlying (i.e., beneath the foot-support expanse) rollers may be employed to suit different circumstances, with the understanding that there should be some arrangement preferably including both fore and aft rollers.

Further, and as will become appreciated by those generally skilled in the relevant art, different arrangements of different wheel diameters and axial thicknesses may be employed as desired. Specific illustrations and discussions herein of particular wheel configurations and sizes, etc., are therefor to be understood to be illustrations and discussions of preferred configurations and sizes which have been proven to be very effective for practicing the methodology of the invention.

Those skilled in the art will recognize that practical variations in traveler design within the context of the present invention may encourage and promote differently attainable improvements in the desired enhancement of range of motion for different people.

A suitable releasable binding structure is preferably provided for the traveler to anchor and stabilize the foot on the foot support expanse furnished by the traveler body's platform.

With such a traveler provided to a knee-surgery patient ( the chosen illustrative setting for describing the present invention) for use, and with the important understanding that use of this traveler in the practice of the invention involves “active” use by a patient, in the sense that patient provides essentially all, relevant, muscle-exercising motive power during therapy, the patient places the relevant foot on the foot-support expanse furnished by the traveler, secures the foot to the traveler, with the heel situated in a traveler-provided heel-support cup, assumes an appropriate sitting position, such as on a chair, adjacent and above a motion-guidance surface on and over which continuous-contact rolling action of the traveler is to take place, and then swings the lower leg back and forth (i.e., fore-and aft) keeping the rollers of the traveler, as was just suggested, in full and continuous rolling contact with the underlying rolling-support, motion-guidance surface. The patient, aided by the foot being secured to the traveler, and by keeping the traveler, preferably, but not necessarily, in continuous front-and-rear rolling contact (at least one always in rolling contact) with the underlying motion-guidance surface, performs this reversible motion activity with the long axis of the foot remaining, and also preferably for most therapy practices, at a substantially constant angle in space. As has been suggested herein above, at least one, underlying, rolling-support roller remains in contact with an underlying rolling-support surface during practice of the invention. Additionally, some angular rocking of the foot's long axis may occasionally occur, or may, in certain instances, be desirable in accordance with the particular knee condition of a person using the invention.

This just-above-mentioned, preferred action, which is a highly effective range-of-motion-improving therapy action, produces important reversible angular relative motion, through “hinging afforded by the replacement knee joint, between the upper and lower legs, and also produces therapy-assisting relative angular motion between the long axes of the lower leg and the associated foot. Constant rolling contact (via at least one roller) through the traveler with the underlying motion-guidance surface furnishes low-friction ease of repetitive lower leg swinging and angular movement back and forth to exercise the new knee joint and the relevant muscle structure, encourages beneficially lengthy exercise times as well as large angular motions, and thereby promotes, as we have observed in prototype and experimental tests, rapid range-of-motion recovery.

While, in relation to the practice of the invention from a patient's benefit point of view, as such practice has been generally expressed above, we have determined that a preferred form of traveler is one having the upwardly extending arch mentioned above, with there existing a forward and upward overall inclination in the body of the traveler (because of the different sizes of the roll diameters of the front and rear rollers which support the underside of the traveler's body), we appreciate that modified forms of a traveler, such as those suggested above, may be employed beneficially in different circumstances.

It will be evident from the brief and general discussion just presented above that the apparatus of the invention is extremely simple in construction, and that practice of the invention is also extremely simple and quite intuitive, in relation to providing angular range-of-motion therapy to a patient who has received a new surgically installed knee joint. The various features and use advantages, in addition to those suggested above, which are attained by the structure and methodology of this invention will now become more fully apparent as the detailed descriptions thereof which follow are read in conjunction with the accompanying drawings.

### DESCRIPTION OF THE DRAWINGS

FIG. 1 is a very simplified lateral elevation schematically illustrating the structure and practice of the present invention. In this figure, the lower part of a patient's body is pictured schematically in a sitting condition on a suitable seat, with fore-and-aft lower-leg movement, and associated angular articulation at the location of a new knee joint, clearly pictured in the figure. This figure also illustrates one form of a suitable rolling-contact, motion-guidance surface which is employed in the practice of the invention.

FIG. 2 is an enlarged-scale, side elevation of the preferred and best mode form of a traveler of the type generally discussed above suitable for use in the manner pictured in FIG. 1.

FIG. 3 is a top perspective view of the traveler pictured in FIG. 2.

FIG. 4 offers a view similar to that presented in FIG. 2, but here showing a modified form of traveler possessing an articulated body hinged generally in the manner suggested above herein.

FIG. 5 provides a view also somewhat like that presented in FIG. 2, but here showing another modified form of traveler whose foot-support expanse is planar rather than arched.

FIG. 6 provides yet another view similar to that presented in FIG. 2, but here showing a modified form of traveler which includes completely same-size traveler-body-support rollers which cause the foot-support expanse furnished by the traveler to lie generally parallel to any provided, or used, underlying rolling-contact support surface beneath the traveler.

### DETAILED DESCRIPTION OF THE INVENTION

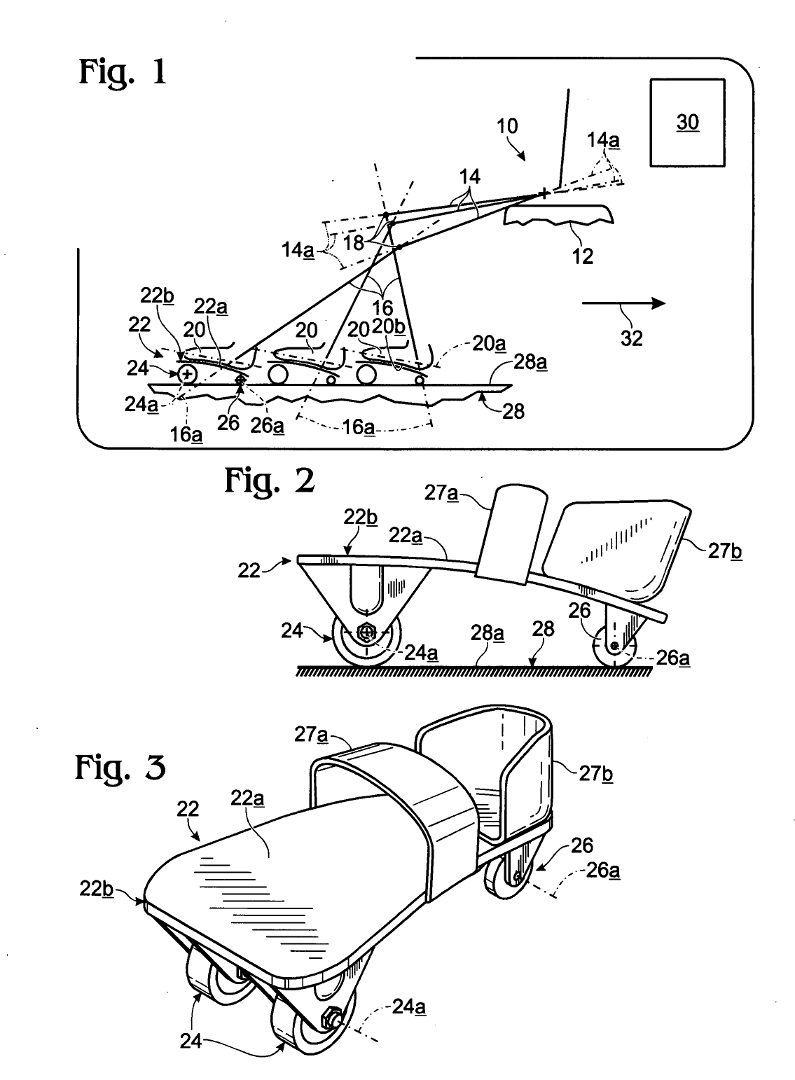

Turning now the drawings, and referring first of all to FIGS. 1 and 2, these two drawings, collectively, fully illustrate both the structure and the methodology of the present invention in their preferred and best-mode forms.

Indicated generally at 10 in FIG. 1, in a highly stylized and schematic side-elevation fashion, is the lower portion of the body of a patient who has had a recent knee-replacement, or knee-joint-replacement, surgery. The illustrated, fragmentary and stylized portion of patient 10 in FIG. 1 is shown seated upon an appropriate seat 12, with the relevant upper leg being shown at 14 having a long axis 14a, the associated lower leg being shown at 16 with a long axis 16a, the new surgically implanted knee joint appearing at 18, and the associated foot being illustrated at 20 having a long axis 20a.

As can be seen, upper leg 14, lower leg 16, knee joint 18, and foot 20 are pictured in FIG. 1 in three different arrangements of relative positions which are useful in describing the patient-invoked methodology of the invention. In order to minimize labeling clutter in FIG. 1, only a single reference numeral is used for each of the three different positions presented for these anatomical structures, except for the foot. These three different positions are most notably characterized by the evident three different left-to-right positions of the foot.

The right-most foot position is associated with an angle of somewhat less than 90-degrees existing between the upper and lower legs' respective long axes. The central position of the foot is associated with an angle between the long axes of the upper and lower legs which is somewhat greater than 90-degrees. Finally, the left-most position of the foot is associated with an angle between the axes of the upper and lower legs which is nearly, though slightly less than, 180-degrees—an angle generally associated with a normal standing position.

One thing to note about these differently illustrated anatomical positions is that, as the lower leg is swung reversibly between the two extreme conditions illustrated in FIG. 1, the axes of the upper and lower legs not only pass reversibly, and significantly, through an intersection angle of 90-degrees, but they also can experience a significant and promoted transition from possessing an included angle of less than 90-degrees, to possessing an included angle of about 180-degrees. Another thing to note is that, throughout such a permitted and encouraged range of angular, lower-leg motion, the angular disposition of the long axis of foot 20 preferably remains substantially constant (though angulation, or rocking, of this axis may occur, and be desirable in certain instances). These several, therapy-enabled conditions offered and promoted by the present invention, and performable by a patient truly with relative and progressive ease, play important roles in rapidly and comfortably restoring and improving range of knee-angulation motion following knee-replacement surgery.

Continuing with what is shown in FIG. 1, as illustrated here, the underside of foot 20 is supported with an upwardly concave, fore-and-aft arch 20b which is urged into the foot by the upwardly extending, convexly curved foot-support expanse possessed by foot-support platform 22a. The underside of body 22b in traveler 22 is supported by a pair of front and rear roller structures, 24, 26, respectively, each of which includes a pair of laterally spaced rollers. The rollers in pair 24 have a shared roll axis 24a, and those in pair 26 have a shared roll axis 26a.

As can be seen, the rollers in pair 24 are larger in diameter than those in pair 26. Also, roll axis 24a is more distant from the foot-support surface in platform 22a than is roll axis 26a. Accordingly, with respect to whatever underlying motion-guidance surface may at any particular time be provided for and supporting rollers 24, 26 for motion, the foot-support surface of platform 20a (regarding the style of traveler now being described) will always be generally upwardly and forwardly inclined in relation to a plane containing the points of contact between the traveler rollers and that surface.

FIGS. 2 and 3 in the drawings illustrate one form of a working embodiment of traveler 22. What can be seen here is that the traveler's foot-support platform has generally the outline of a foot. Additionally, not shown in FIG. 1, but clearly illustrated in FIGS. 2 and 3, is the presence in traveler 22 of a releasable binding strap 27a of conventional construction which may be employed to bind a patient's foot for stabilized anchoring to traveler 22, and specifically to the foot support surface of platform 22a. Additionally included in the traveler is a rear, heel-support cup 27b.

Returning to a description of what is illustrated in FIG. 1, the traveler rollers are there shown in rolling contact with the upper surface 28a (a motion-guidance surface) in a rolling-support structure 28 which is shown only fragmentarily in FIG. 1. Structure 28 may take on a number of different characteristics, one of which is that it is simply a floor in a building, and another one of which is that it is a piece of independent structure forming part of the apparatus of the present invention. In a case where structure 28 is a piece of provided apparatus, it may be designed to present, for patient use, either a horizontal motion-guidance surface, such as surface 28a, or a fore-and-aft-inclined surface which may either incline downwardly and forwardly, i.e., downwardly and to the left in FIG. 1, or downwardly and rearwardly, i.e., downwardly and to the right in FIG. 1. A structure 28 which is positively provided as a component part of the apparatus of the present invention may, if desired, possess a style of rolling-support motion-guidance surface which is other than true planar. Where structure 28 is such a “provided” structure, it is referred to herein as a pre-established motion-guidance structure.

Illustrated in block form at 30 in FIG. 1, and included, if desired, as a useful component in the structure of the invention, is an appropriate instruction set which is provided to a user to describe how to employ the structure of the invention in order to practice the methodology of the invention. This instruction set may take on a variety of different forms, including, as examples, a printed-document form, and an electronic form.

All structure which is provided to a user as componentry of the present invention, whether or not that componentry is limited to a traveler, such as traveler 22, and an instruction set, such as instruction set 30, or whether, in addition to those components, a pre-established motion-guidance structure 28 is provided, the resulting combination of these components is referred herein collectively as leg-motion-guidance therapy structure.

Still referring to FIG. 1, included therein is an arrow 32 which points to the right in the figure. Arrow 32 symbolizes (both structurally and methodologically) one modified form of the invention. From a structural point of view, arrow 32 represents an included resistance-introducing device, such as an elongate elastomer, which may be attached appropriately to traveler 22 to introduce patient-controllable resistance as the traveler advances forwardly over a motion-guidance surface, such as surface 28a. In certain instances, such resistance may offer additional utility in the leg-motion therapy which is offered by the present invention. Where such a resistance device is employed, it should be understood that practice of the invention always is an “active” practice, in the sense that muscular activity of the patient is always required in some ways in the practice of the methodology of the invention.

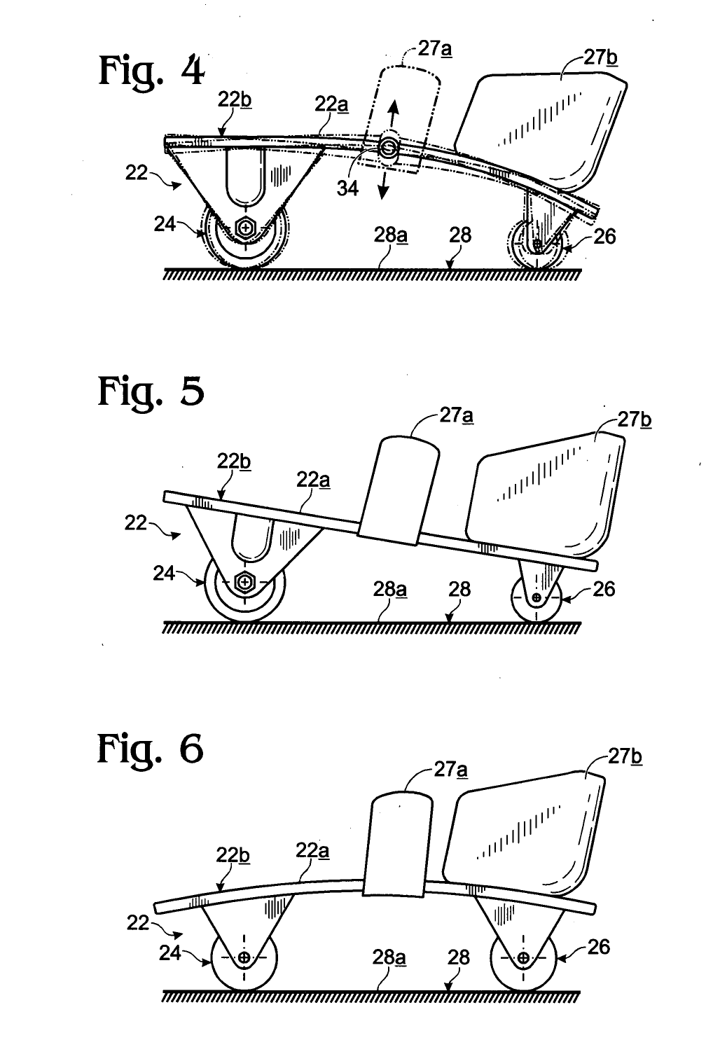

Directing attention now to FIGS. 4, 5 and 6, each of these figures illustrates a different modified form of traveler 22. FIG. 4 illustrates modification wherein the foot-support platform is planar rather than arched. FIG. 5 illustrates a traveler having a hinged body which articulated (hinged) to divide the foot-support platform in two different sections which are thereby reversibly rockable about a generally horizontal hinge axis 34 disposed substantially normal to the plane of this figure. FIG. 6 illustrates a modified traveler wherein the rolling-support rollers all have the same diameters.

As was mentioned earlier herein, other kinds of useful traveler configurations (regarding traveler platform and rollers) may be employed where desired.

Explaining again how the apparatus of the invention is employed to implement the methodology of the invention, we focus attention once more particularly on FIG. 1. With a patient, such as patient 10 seated on a seat, such as seat 12, with the lower leg and the foot depending from the upper leg toward a motion-guidance surface, such as surface 28a, and with traveler 22 supporting the foot as described earlier, the patient, essentially completely under his or her own motive power, swings the lower leg in the context of driving the traveler reversibly, in a translational manner, back and forth along surface 28a. This is done in a manner whereby lower-leg swinging takes place in what is referred to herein as a common swing plane which contains previously mentioned axes 14a, 16a and 20a. Such a swing plane is effectively the plane of FIG. 1.

Such swinging motion, which produces the several angular-motion activities mentioned earlier herein, accompanied, of course, by hinging motion in the new knee joint, all with focused patient-active employment of the relevant muscles, effectively restores, relatively quickly, a range of angular, lower-leg motion which will approach, and hopefully satisfactorily comfortably achieve, a range of motion somewhat like that which is illustrated regarding the left and right extreme locations of the lower leg pictured in FIG. 1.

Significant especially is that practice of the invention is based substantially completely upon “active” behavior of a patient. No outside motion assistance is required or permitted in the correct implementation of the invention regarding important patient muscular activity. Use of a rolling-support traveler in a low-friction environment over a motion-guidance surface as described tends effectively to promote active, patient-motive-power activity. The approach of the invention clearly also promotes lower-leg swinging motion in the mentioned common plane, and this feature plays an important role in rapid restoration of relevant, post-surgery range-of-motion.

Accordingly, a unique therapy system and structure, and a unique patient-active methodology, have been described and illustrated herein.

From one of many possible methodologic points of view regarding the present invention, it may be described as being an active, patient-implementable, range-of-motion recovery practice usable following knee-replacement surgery, and including the steps of (a) occupying a sitting position, (b) by that act of occupying, and by other, subsequent steps of the invention, defining a common swing plane for the lower leg, which plane contains the long axes of the upper leg, the lower leg, the new knee joint, and the foot, (c) supporting the foot continuously for back-and-forth rolling-contact motion over, and effectively in contact with, a selected, underlying, motion-guidance surface, which motion takes place generally within the defined swing plane, and (d) following the act of supporting, and within the defined swing plane, swinging the lower leg in a fore-and-aft manner in the defined plane to produce accompanying back-and-forth rolling-contact motion for the foot over the selected underlying surface.

From a broad structural point of view, the invention may be characterized as taking the form of an active, patient-self-implementable, leg-motion-guidance therapy system for improving the range of motion of upper-leg/lower-leg angular relative motion through the associated, new knee joint following knee-replacement surgery, with this system including (a) a rolling-motion traveler designed, with floor-and-aft swinging, relative to the upper leg, of the knee-connected lower leg which is associated with the knee joint wherein surgery has taken place, to support the contacting underside of the foot for associated back-and-forth rolling travel on and over a selected underlying motion-guidance surface, and (b) an appropriate, cooperative instruction set describing proper patient use of such swinging and traveler rolling, which proper use involves lower-leg swinging generally in an upright plane which is common to, and which contains, the foot's long axis, the lower leg's long axis, the knee, and the upper leg's long axis.

Accordingly, while a preferred and best mode embodiment of both the structure and the methodology of the present invention have been described and illustrated herein, and certain modifications suggested, we appreciate that other variations and modifications may be made which will come within the scope and spirit of the invention.

We claim:

1. An active, patient-implementable, angular range-of-motion recovery practice usable with respect to a knee comprising
occupying a sitting position,
by said occupying, defining a common swing plane for the upper and lower leg,
supporting the foot for back-and-forth rolling-contact motion over and effectively in contact with a selected, underlying motion-guidance surface, which motion is to take place generally within the defined swing plane, and
following said supporting, and within the defined swing plane, swinging the lower leg in a fore-and-aft manner in the defined plane to produce accompanying back-and-forth rolling-continuous-contact motion effectively for the supported foot over the selected surface.

2. The practice of claim 1, wherein said supporting and swinging include creating reversing, relative angular motion between the long axis of the lower leg and the long axis of the foot, whereby the angle between these two axes passes reversibly and recurrently through 90-degrees.

3. The practice of claim 1, wherein said supporting includes forming a supporting-created, concave, fore-and-aft, upwardly rising arch in the underside of the foot.

4. A method for improving the range of upper-leg/lower-leg angular relative motion with respect to a knee joint comprising the following, active, patient-practiceable steps:
assuming a sitting position, with the upper leg in a generally horizontal disposition, and the lower leg and the foot depending from the knee with the long axis of the lower leg disposed approximately at a right angle relative to the long axis of the upper leg;
placing a foot-support traveler, which forms part of a leg-motion-guidance therapy structure, and where the traveler is designed for continuous rolling-contact travel on and over a selected, underlying motion-guidance surface, beneath the lower leg and the associated foot;
utilizing the traveler in a condition of rolling contact with the selected surface, supporting the foot above that surface for reversible, rolling-continuous-contact-motion travel thereover; and
with the foot so supported for such traveler-supported travel, and under self-motive power, recurrently and reversibly swinging the lower leg in a fore-and aft manner, with the foot then simultaneously translating back and forth, under rolling traveler support, on the selected motion-guidance surface, so as to cause such lower-leg swinging generally in an upright plane which is common to, and which contains, the foot's long axis, the lower leg's long axis, the knee joint, and the upper leg's long axis.

5. A method for improving the range of upper-leg/lower-leg angular relative motion in a knee joint comprising the following, active, patient-practiceable steps:
assuming a sitting position, with the upper leg in a generally horizontal disposition, and the lower leg and the foot depending from the knee with the long axis of the lower leg disposed approximately at a right angle relative to the long axis of the upper leg;
placing leg-motion-guidance therapy structure, including a pre-established motion-guidance surface and a foot-support traveler designed for continuous rolling travel on and over that surface, beneath the lower leg and the associated foot;
utilizing the traveler in a condition of rolling contact with the motion-guidance surface, supporting the foot above the motion-guidance surface for reversible, continuous-contact, rolling-motion travel over that surface; and
with the foot so supported for traveler-supported travel, and under self-motive power, recurrently and reversibly swinging the lower leg in a fore-and aft manner, with the foot then simultaneously translating back and forth, under rolling traveler continuous support, on the motion-guidance surface, so as to cause such lower-leg swinging generally in an upright plane which is common to, and which contains, the foot's long axis, the lower leg's long axis, the knee joint, and the upper leg's long axis.

6. The method of claim 5, wherein said supporting is performed in a manner whereby the foot, when so supported, and under a circumstance with the lower leg being oriented in an approximately vertical condition, is disposed with its long axis lying at an angle of less than 90-degrees relative to the long axis of the lower leg.

7. The method of claim 6, wherein said less-than-90-degrees-angle supporting is accomplished by the traveler's possession of a foot-support platform carried on fore-and aft roller structures each associated with a respective roll axis, where the roll axis which is associated with the fore roller structure being located more distantly below the foot-support platform than is the axis which is associated with the aft roller structure.

8. The method of claim 5, wherein said supporting is performed in a manner whereby, because of the configuration of the traveler, the underside of the foot engages the traveler in an upwardly convex arch that is defined by the traveler.

9. The method of claim 5 which further comprises introducing selected resistance to rolling travel of the traveler.

10. The method of claim 5, wherein said foot supporting by the traveler includes introducing articulating by the traveler about at least one axis which is disposed generally normal to the mentioned common plane.

11. The method of claim 5 which further comprises engaging in a non-patient-implemented precursor practice of supplying the patient with the mentioned therapy structure.

12. A method practiceable, at least in part, by a patient for improving the range of angular motion in a knee joint comprising
providing, for use with respect to the patient's knee joint, a specialized, leg-motion-guidance therapy structure, including a rolling-motion traveler, which promotes defined, patient-invoked, reversible, lower-and-upper-leg, interdependent rocking motions accompanied by (a) defined angular relative motion at the ankle between the associated lower leg and the associated foot, and (b) reversible translation of the associated foot via the traveler over a selected, motion-guidance surface,
by the patient,
assuming a sitting position, with the upper leg in a generally horizontal disposition, and the lower leg and the foot depending from the knee toward the motion-guidance surface,
in association with said assuming, and utilizing the provided therapy-structure traveler, supporting the foot, via its underside, in a condition above the selected motion-guidance surface for effective rolling-motion continuous contact with, and reversible translation over and along, that surface, and
recurrently, and under self-motive power, swinging the lower leg reversibly, with the foot then simultaneously, under traveler-furnished, continuous rolling support, translating back and forth along the selected motion-guidance surface generally in an upright common plane which commonly contains the foot, the lower leg, the knee joint, and the upper leg.

13. The method of claim 12, wherein the provided therapy-structure traveler includes an upwardly convex, foot-support platform intended for receiving directly the underside of the foot, thus to produce therein a fore-and-aft, upwardly extending, concave arch, and which further comprises utilizing the platform structure to produce such an arch.

14. The method of claim 12, wherein the provided therapy-structure traveler includes a foot-support platform with a foot-support surface intended for receiving directly the underside of the foot, with the platform and its support surface being articulated for angulating about at least one axis which is disposed generally normal to the mentioned common plane.

15. The method of claim 12, wherein said providing of a therapy structure includes furnishing a pre-established motion-guidance structure usable with the included therapy-structure traveler.

16. An active, patient self-implementable, leg-motion-guidance therapy system for improving the range of upper-leg/lower-leg angular relative motion in a knee joint of that patient comprising
a rolling-motion traveler designed, with fore-and-aft swinging, relative to the upper leg, of the knee-connected lower leg which is associated with the mentioned knee joint, to support the contacting underside of the associated foot effectively for back-and-forth, continuous-contact, rolling travel on and over a selected, underlying, motion-guidance surface, and
an appropriate, cooperative instruction set describing proper patient use of such swinging and traveler rolling, which proper use involves such lower-leg swinging generally in an upright plane which is common to, and which contains, the foot's long axis, the lower leg's long axis, the knee joint, and the upper leg's long axis.
